(19) United States
(12) Patent Application Publication
(10) Pub. No.: US 2005/0083560 A1
(43) Pub. Date: Apr. 21, 2005

(54) Device and methods for making a pixilated directional diffuser having novel applications

(76) Inventor: Tom Cvetkovich, Youngstown, OH (US)

Correspondence Address: Robert G. Lev, 4766 Michigan Boulevard, Youngstown, OH, 44505, US

(21) Appl. No.: 10/738,568

(22) Filed: Dec. 17, 2003

Related U.S. Application Data
(60) Provisional application No. 60/512,329, filed on Oct. 17, 2003.

(51) Int. Cl. G02B 5/32

(52) U.S. Cl. 359/15; 359/294

(57) ABSTRACT

The present invention is directed to a system and method of operating that system for creating a new product, a pixilated directional diffuser. The process uses only a single EMF beam, preferably a laser rather than the split laser, beams of the conventional art.

This application is based upon Provisional Application Ser. No. 60/512,329, which was filed on Oct. 17, 2003.

### FIELD OF THE INVENTION

The present invention relates generally to the field of making and using a range of products known as directional diffusers. In particular, the present invention is directed to a particular method, and systems for supporting that method of producing a directional diffuser product that can be used for decorative purposes, or the utilitarian purposes of redirecting light.

### BACKGROUND OF THE INVENTION

Directional diffusers are a modification of standard diffusers, such as Gaussian diffusers. The modifications distinguishing directional diffusers were developed to overcome the limitations of standard diffusers, and to provide new functional characteristics. Accordingly, the contrast between standard diffusers and directional diffusers is provided in operative terms.

Generally, if a conventional diffuser is illuminated with approximately collimated incident light, it transforms the incident beams into a light pattern with a given angular distribution. The diffuser usually decreases the light brightness and the direction of propagation while at the same time increasing the brightness in other directions. Nevertheless, a standard light diffuser always produces lower brightness for directions different from the propagation direction of the illuminating beam.

As a result, there are severe limitations on the angles at which a display using a standard light diffuser can be observed. Often, it is necessary to have a very bright, high-powered light source, and awkward and expensive disadvantages. In many cases, when the available light is limited, the directions from which a standard diffuser can be useful are extremely limited.

One conventional solution is the use of fiber-optic diffusers. These diffusers redistribute the incident light by transmitting it through a short length of optical fiber. Unfortunately, this type of diffuser is relatively complicated, and thus expensive. A simpler less expensive type of device is needed for accurately redirecting light, or placing exact patterns on a substrate for purposes of light diffraction.

One solution is the use of directional or high-gain diffusers that direct light in predetermined patterns and directions. These devices are finding an increasing number of uses in the control of light distribution and intensity.

Optical directional diffusers, also known as polarized or high gain diffusers depending upon their particular application, are used for improving the light uniformity of illuminating systems. There are other uses. For example, directional diffusers can also be used for producing a directional redistribution of incident light.

One example is that of brightening an image projected on a screen to be viewed from a particular direction. If used in display devices, both aspects of direction diffusers are important since the illumination uniformity and image brightness for the desired observation directions are important.

By properly directing the light, the available light can be used more efficiently, resulting in brighter images for predetermined angles of observations. This is a definite improvement over non-directional light diffusers. Also, directional diffusing screens provide better brightness uniformity across the entire screen, for a predetermined selected point of view. One example of this is use of directional diffusers is found in U.S. Pat. No. 4,372,639 to Johnson, issued Feb. 3, 1983, incorporated herein by reference.

However, there are a number of limitations to the techniques disclosed in the conventional art. For example, they are cumbersome and difficult to implement. The cost of manufacturing these diffusers is also sufficiently high so that economics prevent the deployment of directional diffusers in many application where they would be useful.

Solutions to these drawbacks have been disclosed in U.S. Pat. Nos. 4,586,780 and 4,586,781, incorporated herein by reference to provide additional background information. These devices use fiber-optic faceplates to eliminate zero order light from a holographic diffusing screen, and provide a rudimentary form of chromatic correction. Nonetheless, the final product is expensive and has numerous drawbacks, including only a limited chromatic correction, to justify a difficult and expensive manufacturing process.

All of the examples of conventional art have substantial drawbacks. In particular, it is very difficult to obtain precise patterns for directional diffusers, thereby limiting their usefulness in decorative devices. Conventional products lack precision in that decorative images are very difficult to create, as are exact light directing configurations. Further, most conventional directional diffusers are inefficient. Inefficiency is also found in the manufacturing methods used for producing the directional diffusers, especially when manufacturing large numbers. Accordingly, there is a great deal of room improvement in both the final directional diffuser product, and the manufacturing techniques for producing these products.

### SUMMARY OF THE INVENTION

Accordingly, it is a primary object of the present invention to correct or otherwise limit the drawbacks of the conventional art with regard to the manufacture and use of the directional or high gain diffusers.

It is another object of the present invention to produce directional diffusers in a manner that facilitates mass production.

It is a further object of the present invention to manufacture directional diffusers on a wide variety of different substrates using mass production techniques.

It is an additional object of the present invention to manufacture a master directional diffuser for mass production, using simple manufacturing techniques.

It is still another object of the present invention to provide high gain diffusers constituted by precise predetermined patterns.

It is again a further object of the present invention to provide a method of manufacturing directional diffusers that can easily encompass the use of a wide range of different patterns at little additional cost.

It is still another object of the present invention to provide a method of manufacturing a directional diffuser in which precise light directing patterns can be incorporated.

It is yet an additional object of the present invention to provide directional diffusers arranged to precisely handle light so as to brighten or shade predetermined areas beneath a substrate containing the directional diffuser pattern.

These and other goals and objects of the present invention are accomplished by a system for making a directional diffuser. The system has a source of single beam EMF (Electro Magnetic Force) radiation, directed sequentially through other elements of said system. These other elements sequentially include a rotating cylindrical lens, a diffuser, and a photo-definable material, which is selected to be altered by the single beam of EMF radiation. There is also a controller for operating the source of EMF radiation and the x-y moveable stage to irradiate the photo-definable material on a pixel-by-pixel basis.

A further manifestation of the present invention is found in a system for making a directional diffuser. The system has a source of single beam EMF radiation directed sequentially through the other elements of the system. These elements sequentially include a rotating directional diffuser, and a photo-definable material selected to be altered by the single beam of EMF radiation.

An additional manifestation of the present invention is found in a system for making a directional diffuser. The system has a source of single beam EMF radiation directed sequentially through other elements of the system. These elements sequentially include a rotating directional diffuser, an aperture, and a focusing lens. Also included is a photo-definable material selected to be altered by the single beam of EMF radiation.

Another manifestation of the present invention is found in a process for producing a directional diffuser. The process includes the sequential steps for generating a single beam of EMF radiation. Then the single beam is passed through a rotating cylindrical lens, and then through a standard diffuser. The beam interfaces with the photo-definable material. The beam is moved with respect to the photo-definable material by moving an x-y stage holding the photo-definable material. This movement is made in coordination with the rotation of the cylindrical lens and the generation of the single beam in order to create a pattern of directionally diffused pixels on the photo-definable material.

In a further manifestation of the present invention a process for producing a directional diffuser includes a number of sequential steps. The first is to generate a single beam of EMF radiation. Then the single beam is passed through a directional diffuser which rotates. Finally, the beam interfaces with a photo-definable material.

An additional manifestation of the present invention is found in a process for producing directional diffuser having a number of sequential steps. The first step is to generate a single beam of EMF radiation. Then, the single beam is passed through a directional diffuser which rotates. Then, the single beam is passed through an aperture and then an optical lens. Finally the beam interfaces with a photo-definable material.

The result of the aforementioned processes and systems is a directional diffuser formed from a single beam of EMF radiation in a pattern of discrete independently formed pixels.

### BRIEF DESCRIPTION OF THE DRAWINGS

FIG. 1 is a schematic depicting the system of the present invention operating in first mode.

FIG. 2 is a schematic depicting the system for carrying out the present invention operating in a second mode.

FIG. 3 is a schematic diagram depicting the system for carrying out the present invention operating in a third mode.

### DETAILED DESCRIPTION OF THE PREFERRED EMBODIMENTS

The present invention is a directional diffuser configured on a pixel-by-pixel basis so that each pixel constitutes an individual directional diffuser. The resulting diffuser product can be adapted to a wide variety of uses, in both lighting control and decorative products. The diffuser product has a burnished metallic look (as opposed to a standard hologram which has an extremely reflective metallic appearance.)

The inventive product is characterized as an A chromatic white in appearance. This is in distinct contrast with a standard holographic finish. The burnished metallic look of the inventive product is the result of a non-diffractive pattern, where each of the pixilated directional diffusers is formed independently with its own particular set of characteristics, such as the direction from which light is either shaded or enhanced. Further, in distinct contrast to standard holography, the finished product of the present invention exhibits no “rainbow phenomenon”.

The inventive diffuser product is extremely versatile because it can be configured in virtually limitless range of patterns on a very wide range of substrates. Accordingly, the directional diffuser of the present invention can be used for decorative purposes as well as the control of lighting in a wide range of different environments and applications.

This versatility is achieved by a simple, inexpensive manufacturing system, as depicted in the drawings, which depict a number of inventive variations for the inventive process. The use of a single EMF (Electro Magnetic Force) beam, preferably a laser, which is undivided (as is done with conventional techniques) renders the manufacturing process of the present invention simpler and less expensive than conventional processes. Based upon the inventive processes, the resulting product is a series of diffused dot matrix kinetic patterns, where the reflection angle (and where desired, the shape) for each dot (or pixel) is individually controlled to obtain a specifically configured diffuser product.

The inventive diffuser product is different from conventional directional diffusers in that the direction of diffusion can be controlled on a pixel-by-pixel basis. The flexibility and control facilitated by the inventive method allows new applications for directional diffusers. This includes products such as decorative packaging materials, window shades, artwork, illustrations, advertising, substrates for a wide variety of independent overlaid artwork, decorative screens, signs, or a wide variety of rigid and semi-flexible substrates.

Masters, created by the techniques of the present invention, can be made on a wide variety of different materials. Depending upon the materials constituting the master, embossing or other transfer means can be used to imprint a wide variety of other materials used in mass copying.

Functional devices such as lamp housings streetlights, office lighting or hospital lighting can be made using the resulting directional diffusers. Any application requiring precise control of light distribution can be facilitated by the present invention. The ease and inexpensiveness of manufacture further facilitates the production of different types of masters for a wide range of products to be imprinted with the directional diffusing patterns from the masters made using the inventive processes.

The process (preferably controlled by computer 200) requires only a single EMF beam. Preferably the EMF beam is constituted by light, usually a monochromatic laser. However, other types of single beam radiation, including multi-chromatic laser light, can serve for this present invention. The generation and control of the single EMF beam can be handled in a variety of ways known in the conventional art.

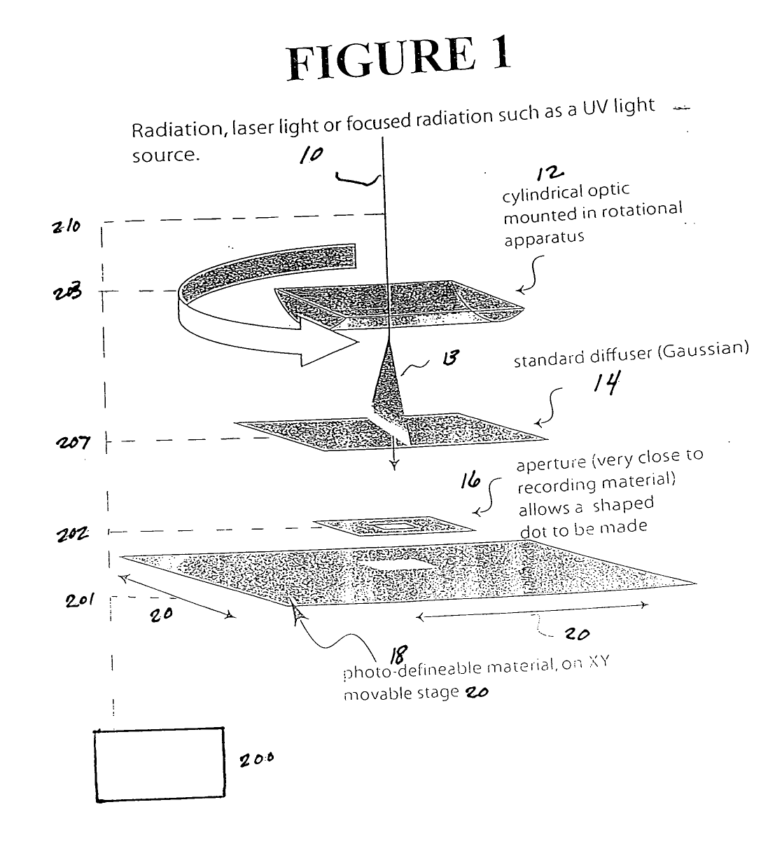

As depicted in FIG. 1, the EMF beam 10 is passed through a cylindrical lens 12 to form a beam of light 13, which then illuminates a standard diffuser 14, such as a Gaussian diffuser, constituted, for example, by ground glass. The modified light beam is then passed through a small aperture 16 close to the sauce of a photosensitive material 18. Virtually any photo-definable material, i.e. a material whose surface can be shaped either directly with light or via light, and a subsequent chemical or thermal, process can then be applied. Photo-resist materials or photo-polymers are examples of materials that can be used with the present invention.

It should be understood that a wide variety of standard diffusers can be used, and that a Gaussian diffuser, is not necessary. Also, a wide variety of aperture shapes can be used for aperture 16. Preferably the aperture is located 2 mm or less from the photo-definable surface. The photo-definable material 18 can be any of a wide range of materials that can be photo-deformed or otherwise ablated by the single EMF beam 10.

The cylindrical lens 12 is mounted in such a way as to allow it to be rotated about its axis. Further the photo-definable material is mounted upon an x-y table 20, allowing it to be moved incrementally in a standard raster fashion (using computer controlled actuator 201).

While the x-y table 20 is depicted as a rectangular structure, the present invention is not limited thereby. Rather, the x-y table can be a cylindrical arrangement, which is particularly efficacious for creating masters used in embossing foil or plastic. Further, the shape of the x-y table can be any that is suitable for any of the many kinds of substrates that can be photo-deformed by the inventive process.

Upon development of the photo-definable material 18, a high gain diffuser, also known as a directional diffuser is formed. Because the cylindrical lens 12 can be rotated, (by computer controlled actuator 203) the direction of greatest diffusion can be controlled on pixel-by-pixel basis.

At least one computer 200 is programmed with the pattern or image to be created. Based upon this data, the computer controls the gating of beam 10 (actuator 210), the rotation of lens 12 (actuator 203), and, optionally the placement of aperture 16 (actuator 202), as well as the movement of x-y table 20 (actuator 201) in a coordinated manner. This type of computer control was limited to the splitting of a monochromatic laser beam to form a holographic pattern using well-known holography techniques, as disclosed in the following Davis U.S. Pat. Nos. 5,262,879; 5,822,092; and, 6,486,982, all incorporated herein by reference.

A major difference in the systems of the cited patents and the present invention is that only a single EMF beam 10 (preferably a laser) is used in pixilated fashion while obtaining the same level of precision found in the cited patents. Further, the present invention permits holographic masters to be formed on a wide range of materials, thereby permitting imprinting or embossing upon a wider range of materials. Computer control can be used to adjust the position of standard diffuser 14 by means of a computer-controlled actuator 207. Likewise, the position of aperture 16 can be adjusted by computer-controlled actuator 202. Also, the shape and size of a variable aperture can also be affected by using computer control. While this additional computer control is not necessary for the operation of the present invention, there will be situations in which it is desirable.

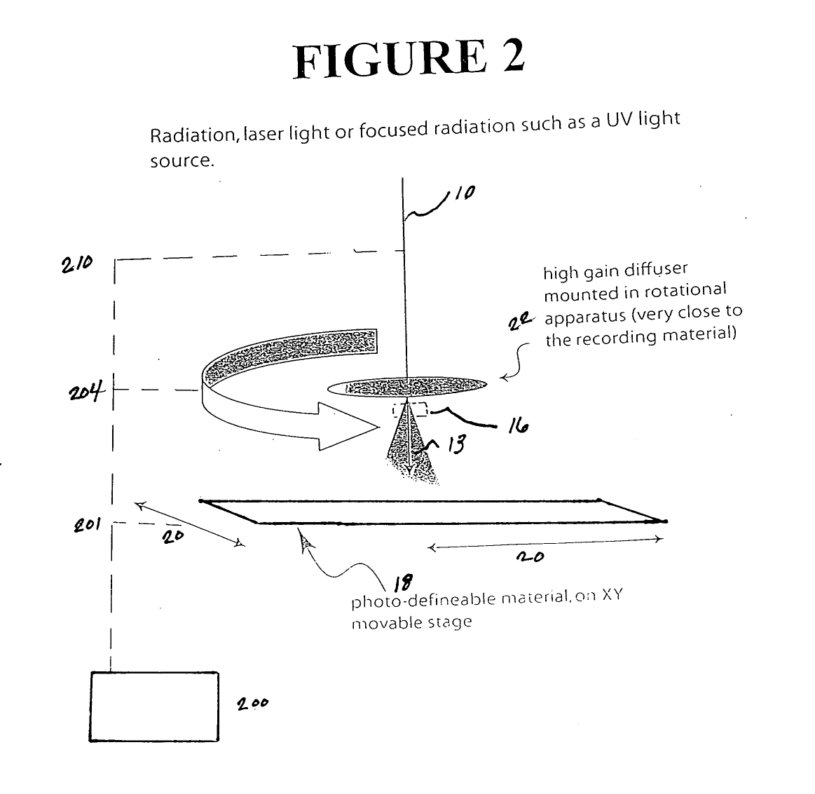

FIG. 2 depicts a modification in the system of FIG. 1. A preexisting high-gain or directional diffuser 22 replaces the cylindrical lens 12 and standard diffuser 14. If the directional diffuser 22 is placed 2 mm or less from the photo-definable material, the aperture 16 can be eliminated. However, the aperture 16 can remain at approximately 1 mm or less from the photo-definable material. In this embodiment, computer 200 controls the x-y moveable stage 20 through actuator 201. The rotation of directional diffuser 22 is controlled by actuator 204, which can be used to adjust the distance of the high-gain diffuser from the photo-definable material 18 as well as controlling rotation. The gating of EMF beam 10 is controlled by actuator 210 in the same manner as the embodiment of FIG. 1. If aperture 16 is used, it can also be controlled by computer 200.

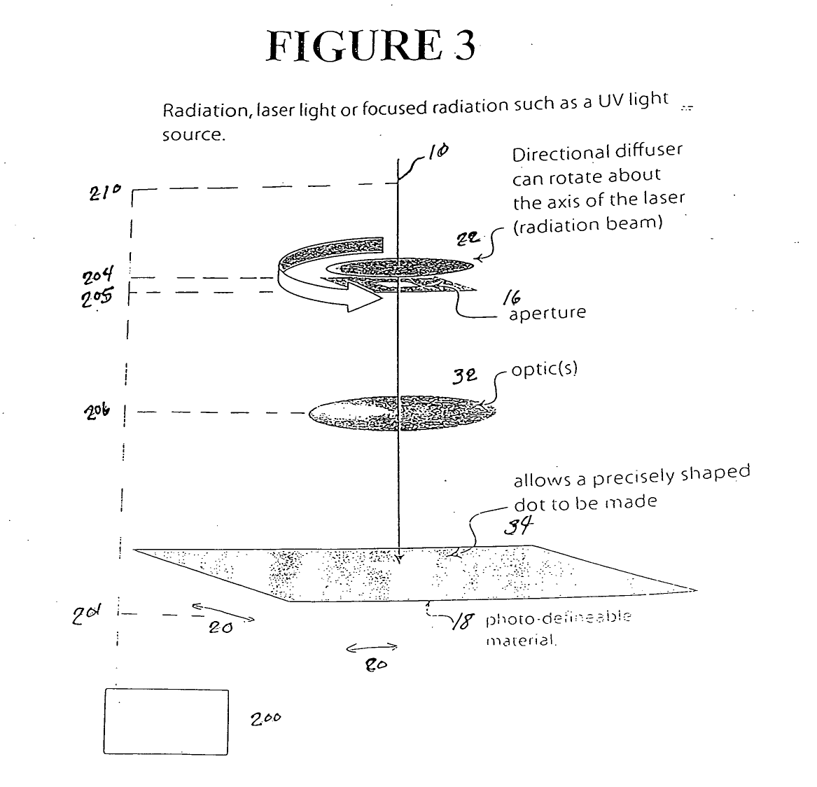

By using a lens to image an aperture upon the recording material a highly defined pixel shaped by the aperture can be produced. In methods depicted by FIGS. 1 and 2, the pixel will be oval shaped and soft edged. However, in method depicted by FIG. 3, the pixel 34 can be any shape desired. Square or hexagonal shapes are generally the most useful. It should be understood that the use of the adjustable aperture 16, many different pixel shapes can be obtained, including: square; hexagonal; oval; circular; triangular; octagonal; and, any number of different parallelograms.

The FIG. 3 embodiment is best adjusted by placing aperture 16 within approximately 1 mm of directional diffuser 22. It should be understood that all elements have their operation coordinated through computer 200. Thus, the position of various elements can be adjusted to obtain the optimum size and shape of the final pixilated diffusers. Further, it should be understood that while x-y moveable stage 20 is preferred, the photo-definable material 18 can be placed on a static surface while the optical apparatus (including directional diffuser 22, aperture 16, optics 32) are moved instead.

The process of producing a pixilated directional diffuser for a graphics application, such as a decorative film for packaging or a book cover, begins with a drawing of the artwork in question. The various elements of the artwork are assigned an angle at which they would appear most bright in the final product. Computer graphics files are created to correspond to each of these unique elements, for example the figure and the background around the figure, anything that occurs to the designer.

Software is designed which could interpret each of these areas and control the systems depicted in the figures (including the computer controlled actuators). The system then changes the x-y position of the moveable stage 20 on which the photo-definable material 18 rests. The computer 200 also controls the angle of greatest diffusion. In this system of FIG. 1 and angle of diffraction is controlled by the ground glass diffuser 14 and cylindrical lens 12. In the methods of FIGS. 2 and 3 this function is performed by the pre-existing high gain diffuser 22. A computer controlled synchronized shutter system can be used to expose the photo-definable material 18 on a pixel-by-pixel basis.

In normal operation the system is loaded with the photo-deformable material 18 and the computer program is run. Upon completion any further processing required of the material, such as wet development of photo resist material 18, or baking of photo polymers is carried out. The result is a master from which multiple pixilated directional diffusers can be manufactured.

The master (a series of microstructures constituted by diffused dots or pixels) thus produced in the photo-deformable material would then be copied by any one of several micro-replication techniques. These techniques include electroplating and casting, and are well known. The first generation copy is generally of a more robust nature (usually due to a stronger substrate), and is used as a tool for mass replication.

Mass replication of the microstructures can be achieved by a variety of techniques including hard and soft micro embossing, UV curable replication, injection molding and casting techniques. These methods are well known within the holography industry. Likewise any of the techniques for mass replication of microstructures could be used to reproduce the pixilated directional diffuser patterns/images.

A range of consumer products could be made from these techniques including hot stamped foils and plastics, and films for lamination to board stock, and the like. The products that can be mass-produced are not limited to foils. The mass-produced embossed copies can be made using a wide variety of materials susceptible to mass-production techniques.

For functional applications, such as sophisticated lighting control for machine vision instruments and lighting for general work and home environments, the steps are the same except that the process begins not with a piece of graphics but with a desired distribution pattern for light. The pixilated diffuser pattern necessary to produce this light distribution is calculated based upon the specific parameters of a particular lighting requirement, including the light source and the distances involved.

Decorative films produced with the invention exhibit a sheen or high light not unlike brushed metal surfaces. The effect can be oriented in any given direction and the combination of various directions gives an animated effect as the viewer moves with relation to the film.

The present invention allows rolls of film material to be produced having these qualities. These rolls of film can be used wherever decorative foils or films are currently being used such as advertising in print media, book and magazine covers, and packaging of all sorts. The effect is produced from the microstructure on the film and can be applied to many substrates, foils, including such as hot stamp foil, PET, polypropylene, polyethylene, OPP, triacetate, paper, Mylar.

When used as functional light-forming tool the pixilated directional diffuser could be in the form of a “shade” between the light and the desired area of illumination. In this case it will be most often desirable to fabricate the inventive pixilated directional diffuser on a rigid substrate, such as plastic or glass, which can be done with laminating techniques or by directly forming the microstructure in the shade with casting, or injection molding techniques.

While a number of embodiments by way of example, the present invention is not limited thereby. Rather, the present invention should be construed to encompass a novel system (with variants), methods of operating those systems, and at least one novel product. The present invention covers all modifications, variations, derivations, manifestations, and embodiments that would occur to one skilled in this technology once having been taught the invention. Accordingly, the present invention should be construed as limited only by the following claims.

1. A system for making a directional diffuser having a source of single beam EMF radiation directed sequentially through other elements of said system, sequentially comprising:
a. a rotating cylindrical lens;
b. a diffuser,
c. photo-definable material selected to be altered by said single beam of EMF radiation; and,
d. means for operating said source of EMF radiation and x-y moveable stage to irradiate said photo-definable material on a pixel-by-pixel basis.

2. The system of claim 1, further comprising:
e. a shaping aperture between said diffuser and said photo-definable material.

3. The system of claim 2, wherein said aperture is very close to said photo-definable material for purposes of shaping said single beam of EMF radiation to one selected from a variety of predetermined configurations.

4. The system of claim 1, wherein said single beam of EMF radiation comprises light from a laser.

5. The system of claim 1, wherein said x-y moveable stage and said source of EMF radiation are computer-controlled.

6. The system of claim 5, wherein said x-y moveable stage is cylindrical in shape.

7. The system of claim 2, wherein said aperture is arranged 2 mm or less from said photo-definable material.

8. A system for making a directional diffuser having a source of single beam EMF radiation directed sequentially through other elements of said systems, sequentially comprising:
a. a rotatable directional diffuser; and,
b. a photo-definable material selected to be altered by said single beam EMF radiation.

9. The system of claim 8, wherein said directional diffuser is mounted 2 mm or less from said photo-definable material.

10. The system of claim 8, wherein said single beam of EMF radiation comprises light from a laser.

11. The system of claim 9, further comprising:
c. An x-y moveable stage supporting said photo-definable material.

12. The system of claim 11, wherein said x-y moveable stage is cylindrical in shape.

13. The system of claim 11, further comprising:
d. means for operating said source of EMF radiation and said x-y moveable stage to irradiate said photo-definable material on a pixel-by-pixel basis.

14. A system for making a directional diffuser having a source of single beam EMF radiation directed sequentially through other elements of said system, sequentially comprising:
a. a rotating directional diffuser;
b. an aperture;
c. a focusing lens; and,
d. a photo-definable material selected to be altered by the single beam of EMF radiation.

15. The system of claim 14, wherein said aperture is located within 1 mm of said rotating directional diffuser for purposes of shaping said single beam of EMF radiation to one selected from a variety of predetermined configurations.

16. The system of claim 15, wherein said aperture is variable admitting to a number of different shapes with which to configure said single beam of EMF radiation

17. The system of claim 14, wherein said single beam of EMF radiation comprises light from a laser.

18. The system of claim 14, further comprising:
e. means for controlling said single beam of EMF radiation and said x-y moveable stage to irradiate said photo-definable material on a pixel-by-pixel basis.

19. The system of claim 18, wherein said x-y moveable stage is cylindrical in shape.

20. The system of claim 18, further comprising:
f. means for controlling said single beam of EMF radiation and said x-y moveable stage to irradiate said photo-definable material on a pixel-by-pixel basis.

21. A process for producing a directional diffuser, comprising the sequential steps of:
a. generating a single beam of EMF radiation;
b. passing said single beam through a rotating cylindrical lens;
c. passing said single beam through a standard diffuser;
d. interfacing said single beam with a photo-definable material; and,
e. moving an x-y stage holding said photo-definable material in coordination with rotation of said cylindrical lens and generation of said single beam to create a pattern of directionally diffused pixels on said photo-definable material.

22. The process of claim 21, wherein after step c and before step d, carrying out a step of passing said single beam through a shaping aperture.

23. The process of claim 21, wherein said single beam of EMF radiation is light from a laser.

24. The process of claim 22, wherein position of said aperture is adjusted with respect to said photo-definable material.

25. The process of claim 24, wherein said aperture is operated 2 mm or less from said photo-definable material.

26. The process of claim 25, wherein the size and shape of said aperture is adjusted through one of a variety of predetermined sizes and shapes.

27. A process for producing a directional diffuser, comprising the sequential steps of:
a. generating a single beam of EMF radiation;
b. passing said single beam through a directional diffuser, and rotating said directional diffuser; and,
c. interfacing said single beam on a photo-definable material.

28. The process of claim 27, further comprising the step of moving an x-y stage containing said photo-definable material in coordination with rotation of said directional diffuser and generation of said single beam to create a pattern on a pixel-by-pixel basis on said photo-definable material.

29. The process of claim 27, wherein said single beam of EMF radiation is light from a laser.

30. The process of claim 28, further comprising the step of adjusting position of said directional diffuser with respect to said photo-definable material.

31. A process for producing a directional diffuser, comprising sequential steps of:
a. generating a single beam of EMF radiation;
b. passing said single beam through a directional diffuser, and rotating said directional diffuser;
c. passing said single beam through an aperture;
d. passing said single beam through an optical lens; and,
e. interfacing said single beam with a photo-definable material.

32. The process of claim 31 further comprising the step of moving an x-y stage containing said photo-definable material in coordination with rotating said directional diffuser and generating said single beam to create a pattern on a pixel-by-pixel basis on said photo-definable material.

33. The process of claim 31, further comprising the step of adjusting position of said aperture within 1 mm or less to said directional diffuser.

34. The process of claim 31, further comprising the step of adjusting position of said optical lens with respect to said photo-definable material.

35. The process of claim 31, wherein said single beam of EMF radiation is light generated by a laser.

36. A directional diffuser formed from a single beam of EMF radiation in a pattern of discrete, independently formed pixilated diffusers.

37. The directional diffuser of claim 36, wherein said pattern of pixilated diffusers is arranged in a predetermined pattern.

38. The directional diffuser of claim 36, wherein said single beam of EMF radiation comprises light from a laser.

39. The directional diffuser of claim 36, wherein said pattern of pixilated diffusers constitutes a predetermined pattern of areas of shape and enhanced brightness on a substrate.

40. The directional diffuser of claim 39, wherein said substrate is arranged as a master from which copies of said directional diffuser are made by at least one of a process selected from a group of processes consisting of casting, injection molding, embossing, thermal transfer, photo transfer, and chemical transfer.

41. The directional diffuser of claim 40, wherein said copies are formed on at least one material selected from a group consisting of paper, metal foil, plastic, polyethylene, polypropylene, Mylar, rubber, OPP, triacetate, and PET.

42. The directional diffuser of claim 36, wherein shapes of said pixilated diffusers are selected from a group of shapes consisting of square, hexagonal, oval, circular, triangular, octagonal, and any parallelogram.

43. The directional diffuser of claim 36, wherein said appearance of said directional diffuser is that of burnished metal.

44. The directional diffuser of claim 36, wherein said directional diffuser is formed as a background substrate of a superimposed design.
